(19) United States
(12) Patent Application Publication
(10) Pub. No.: US 2026/0097520 A1
(43) Pub. Date: Apr. 9, 2026

(54) SYSTEMS, METHODS AND APPARATUSES FOR AUTOMATIC EDGE FORMING

(71) Applicant: GEORGIA-PACIFIC LLC, Atlanta, GA (US)

(72) Inventor: Stephen M. Schroeder, Evans, GA (US)

(21) Appl. No.: 19/115,801

(22) PCT Filed: Sep. 15, 2023
(86) PCT No.: PCT/IB2023/059182

§ 371 Date: Mar. 27, 2025

Related U.S. Application Data
(60) Provisional application No. 63/413,617, filed on Oct. 6, 2022.

(51) Int. Cl. B25J 11/00; B25J 9/16

(52) U.S. Cl. CPC B25J 11/0055; B25J 9/1628; G05B 2219/45068

(57) ABSTRACT

Methods, apparatuses, systems, computing devices, and/or the like are provided. An example edge forming system may include includes a sensing device configured to detect one or more profiles of one or more objects disposed on a production line. The system may include a robotic device. The robotic device may include a first end and a second end, one or more articulating segments disposed between the first and second ends, and a joint disposed at the first end of the robotic device. The system may include an edge forming device fixedly connected to the joint of the robotic device. The robotic device may be configured to position the edge forming device between an engaged position and a disengaged position. The edge forming device may be configured to engage the one or more objects on the production line when the edge forming device is in the engaged position.

### RELATED APPLICATIONS

This application claims the benefit of U.S. Provisional Application No. 63/413,617, filed Oct. 6, 2022 and entitled “SYSTEMS, METHODS AND APPARATUSES FOR AUTOMATIC EDGE FORMING,” which is incorporated by reference herein in its entirety

### TECHNICAL FIELD

The present disclosure relates generally to materials manufacturing, and more particularly to automated edge forming as used in gypsum manufacturing operations.

### BACKGROUND

During gypsum manufacturing (and material manufacturing broadly), the edge of a gypsum board (or other product board) is formed by an edge forming device (also known as a “forming shoe”) that may be manually adjusted (e.g., by a technician) based on measurements taken on the manufacturing line before and/or after cutting the product. However, there may be long wait times between when a technician may adjust the “forming shoe.” These long wait times may lead to inefficiencies and wasted product if the forming shoes are not properly positioned, or if their positions or orientations need to be updated with respect to the gypsum board. This issue may be compounded for large production lines when multiple edge forming devices need adjustment.

Forming shoes may be made of stainless steel or chrome-plated steel and are generally static elements. Over a forming shoe's lifetime, it may wear down and deteriorate due to, among other things, friction from continual contact with the board (or other product on the line). This deterioration may require frequent replacement of forming shoes to ensure that board production continues. Furthermore, debris and contaminants may build up on forming shoes over time and require cleaning (e.g., by a technician).

Through applied effort, ingenuity, and innovation, Applicant has solved problems relating to adjustment of forming shoes in response to feedback, debris and contaminants building up on forming shoes, and friction wearing down forming shoes over time by developing solutions embodied in the present disclosure, which are described in detail below.

### SUMMARY

In general, various embodiments of the present disclosure provide methods, apparatuses, systems, computing devices, computing entities, and/or the like.

According to some embodiments, an automated edge forming system is provided. In some embodiments, the system includes a sensing device configured to detect one or more profiles of one or more objects disposed on a production line. In some embodiments, the system includes a robotic device. In some embodiments, the robotic device includes a first end and a second end, one or more articulating segments disposed between the first and second ends, and a joint disposed at the first end of the robotic device. In some embodiments, the system includes an edge forming device fixedly connected to the joint of the robotic device. In some embodiments, the robotic device is configured to position the edge forming device between an engaged position and a disengaged position. In some embodiments, the edge forming device is configured to engage the one or more objects on the production line when the edge forming device is in the engaged position. In some embodiments, the edge forming device is configured to refrain from engaging the one or more objects on the production line when the edge forming device is in the disengaged position. In some embodiments, the system includes a control device configured to receive the one or more profiles of the one or more objects from the sensing device, process the one or more profiles into feedback, and provide the feedback to the robotic device. In some embodiments, the robotic device is configured to adjust the engaged position of the edge forming device based on the feedback.

In some embodiments, the joint of the robotic device is a rotational joint configured to spin continuously the edge forming device when the edge forming device is in the engaged position.

In some embodiments, the edge forming device is configured to spin continuously when the edge forming device is in the engaged position.

In some embodiments, the system includes a cleaning device configured to clean the edge forming device when the edge forming device is in the disengaged position.

In some embodiments, the system includes a platform adjacent to the production line. In some embodiments, the sensing device is positioned at a first location on the platform. In some embodiments, the robotic device is positioned at a second location on the platform.

In some embodiments, the system includes a second sensing device positioned at a third location on the platform and configured to detect the one or more profiles of the one or more objects disposed on the production line. In some embodiments, the system includes a second robotic device positioned at a fourth location on the platform and including a first end and a second end, one or more articulating segments disposed between the first and second ends, and a joint disposed at the first end of the robotic device. In some embodiments, the system includes a second edge forming device fixedly connected to the joint of the second robotic device. In some embodiments, the second robotic device is configured to position the second edge forming device between an engaged position and a disengaged position. In some embodiments, the second edge forming device is configured to engage the one or more objects on the production line when the edge forming device is in the engaged position. In some embodiments, the second edge forming device is configured to refrain from engaging the one or more objects on the production line when the edge forming device is in the disengaged position. In some embodiments, the control device is configured to receive the one or more profiles of the one or more objects from the second sensor, process the one or more profiles into feedback, and provide the feedback to the second robotic device. In some embodiments, the second robotic device is configured to adjust the engaged position of the edge forming device based on the feedback.

In some embodiments, the first edge forming device and the second edge forming device are configured to be simultaneously engaged with the same object when the first edge forming device and the second edge forming device are in their respective engaged positions.

In some embodiments, the robotic device is configured to slidably move along the platform relative to one or more of the sensing device and the production line.

In some embodiments, the platform is positioned above the production line.

In some embodiments, the platform includes a plurality of slots, and wherein the sensing device may be configured to detect through one or more of the plurality of slots the one or more profiles of one or more objects disposed on the production line.

In some embodiments, the robotic device further includes a base disposed on the robotic device's second end, wherein the base is configured to rotate up to three-hundred-and-sixty degrees.

In some embodiments, the one or more objects on the production line include one or more gypsum boards, and wherein the engagement of the edge forming device with the one or more objects on the production line includes cutting the one or more gypsum boards.

In some embodiments, the one or more profiles of the object include one or more of an angle at which the edge forming device is in the engaged position with the one or more objects, a position of the one or more objects on the production line, a depth at which the edge forming device is in the engaged position with the one or more objects.

In some embodiments, the robotic device is configured to have six degrees of freedom of movement.

In some embodiments, the sensing device is a laser profiler.

According to various embodiments, a method of making an object is provided. In some embodiments, the method includes detecting, by a sensing devices, one or more profiles of the object. In some embodiments, the method includes transmitting, by the sensing device, the one or more profiles of the object to a control device. In some embodiments, the method includes generating, by the control device, feedback based on the one or more profiles of the object. In some embodiments, the method includes transmitting, by the control device, the feedback to a robotic device, the robotic device includes a first end and a second end, one or more articulating segments disposed between the first and second ends, and a joint disposed at the first end of the robotic device. In some embodiments, an edge forming device is fixedly attached to the joint of the robotic device. In some embodiments, the method includes manipulating, by the robotic device, the edge forming device into an engagement position with the object based on the feedback transmitted by the control device to the robotic device. In some embodiments, the method includes manipulating, by the robotic device, the edge forming device into a disengagement position, wherein the edge forming device refrains from engaging the object.

In some embodiments, the object includes gypsum board, and the method further includes cutting, by the edge forming device, the gypsum board.

In some embodiments, the joint of the robotic device is a rotational joint and the method further includes continuously spinning, by means of the rotational joint, the edge forming device.

In some embodiments, the method includes continuously spinning the edge forming device.

In some embodiments, the method includes moving, by the robotic device, the edge forming device into a cleaning device configured to clean the edge forming device.

The above summary is provided merely for purposes of summarizing some example various embodiments to provide a basic understanding of some embodiments of the disclosure. Accordingly, it will be appreciated that the above-described various embodiments are merely examples. It will be appreciated that the scope of the disclosure encompasses many potential various embodiments in addition to those here summarized, some of which will be further described below.

### BRIEF DESCRIPTION OF DRAWINGS

Having thus described the disclosure in general terms, reference will now be made to the accompanying drawings, which are not necessarily drawn to scale, and wherein:

FIGS. 1A-1E are angled views of an example automated edge forming system in accordance with various embodiments of the present disclosure;

FIGS. 1F-1G are side views of an example edge forming device and robotic device in accordance with various embodiments of the present disclosure;

FIGS. 1H-1I are angled views an example edge forming device and robotic device in accordance with various embodiments of the present disclosure;

FIG. 2 is an angled view of an example production line with example automated edge forming systems in accordance with various embodiments of the present disclosure;

FIG. 3 is an angled view of an example edge forming system in accordance with various embodiments of the present disclosure;

FIG. 4 is a diagram illustrating example architecture for an example control device in accordance with various embodiments of the present disclosure;

FIG. 5 is a schematic of an example management computing entity for an example control device in accordance with various embodiments of the present disclosure;

FIG. 6 is a schematic of an example user computing entity for an example control device in accordance with various embodiments of the present disclosure; and

FIG. 7 is a flow chart illustrating an example method of making using an example automated edge forming system in accordance with various embodiments of the present disclosure.

### DETAILED DESCRIPTION

Various embodiments of the present disclosure now will be described more fully hereinafter with reference to the accompanying drawings, in which some, but not all various embodiments of the disclosure are shown. Indeed, this disclosure may be embodied in many different forms and should not be construed as limited to the various embodiments set forth herein; rather, these various embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

Various embodiments of the present disclosure may be implemented as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

Various embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary various embodiments, retrieval, loading, and/or execution may be performed in parallel such that multiple instructions are retrieved, loaded, and/or executed together. Thus, such various embodiments can produce specifically-configured machines performing the steps or operations specified in the block diagrams and flowchart illustrations. Accordingly, the block diagrams and flowchart illustrations support various combinations of various embodiments for performing the specified instructions, operations, or steps.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

### Example Edge Forming Systems and Devices

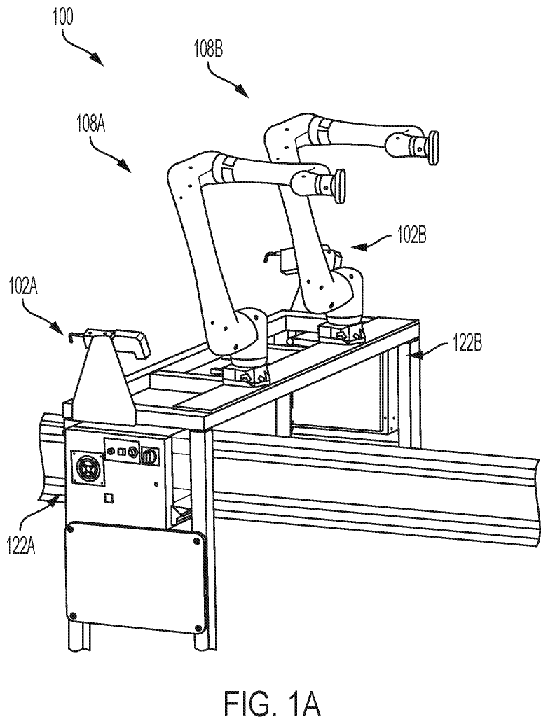

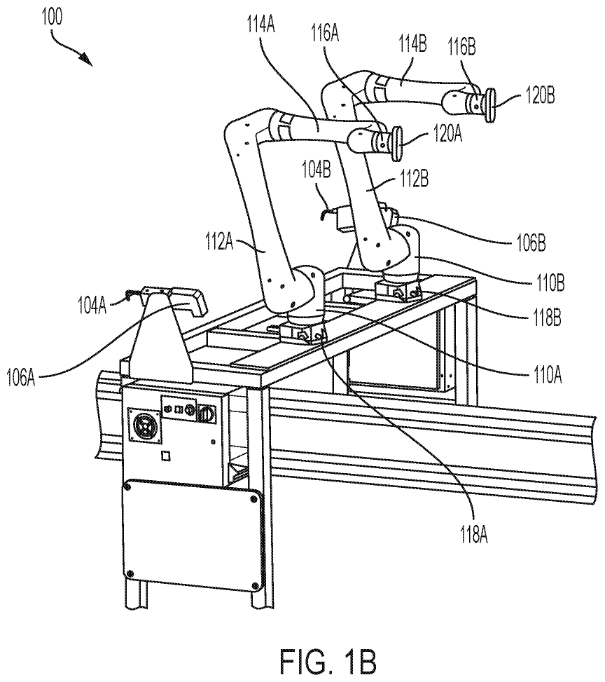

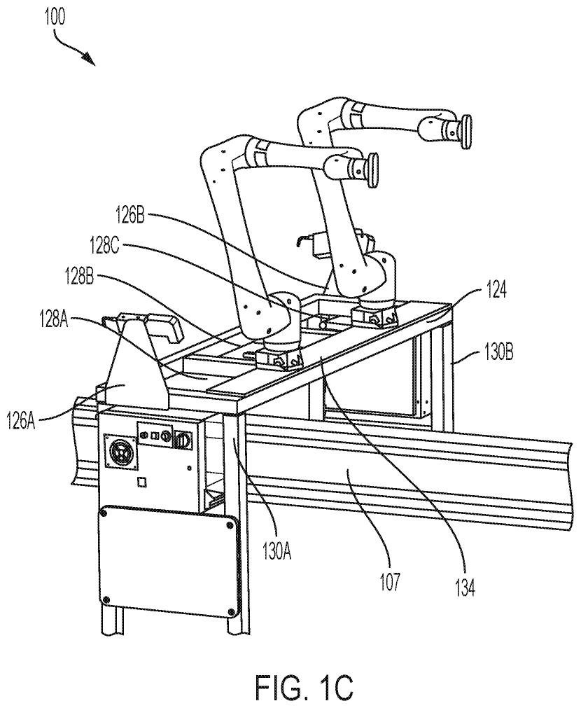

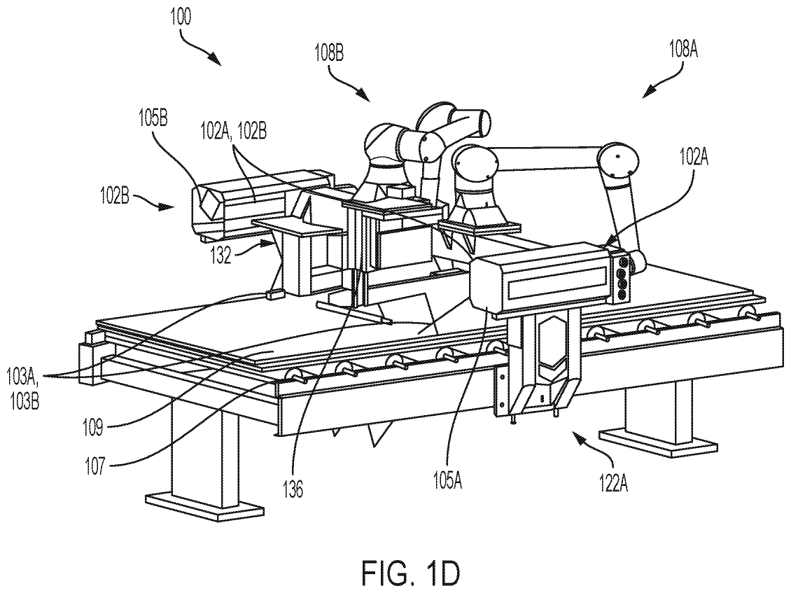

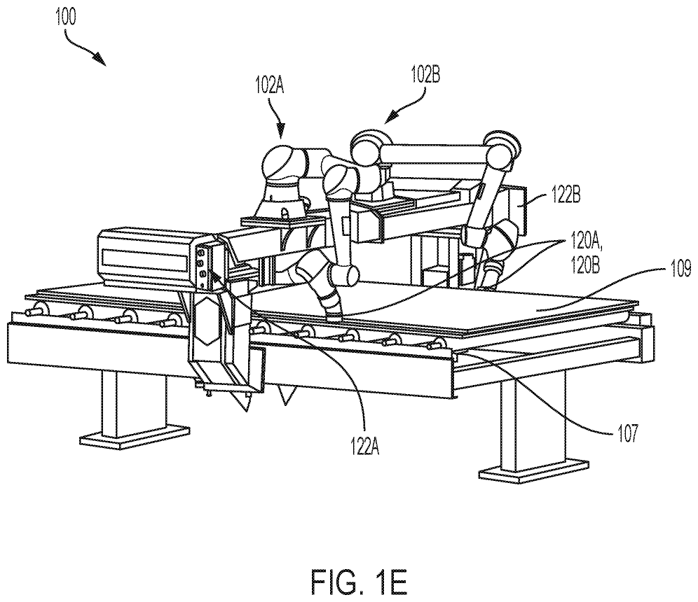

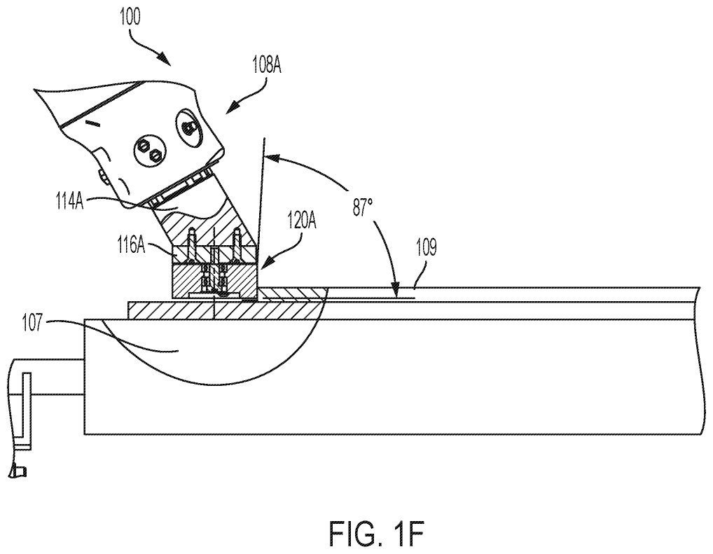

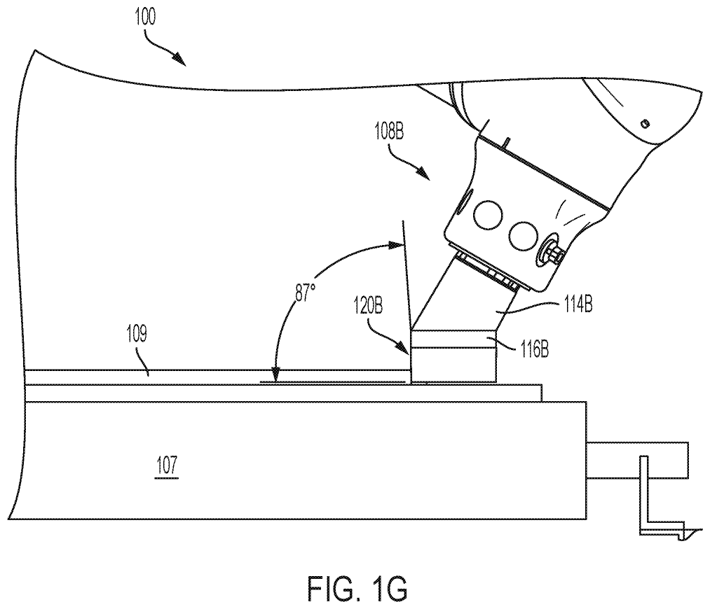

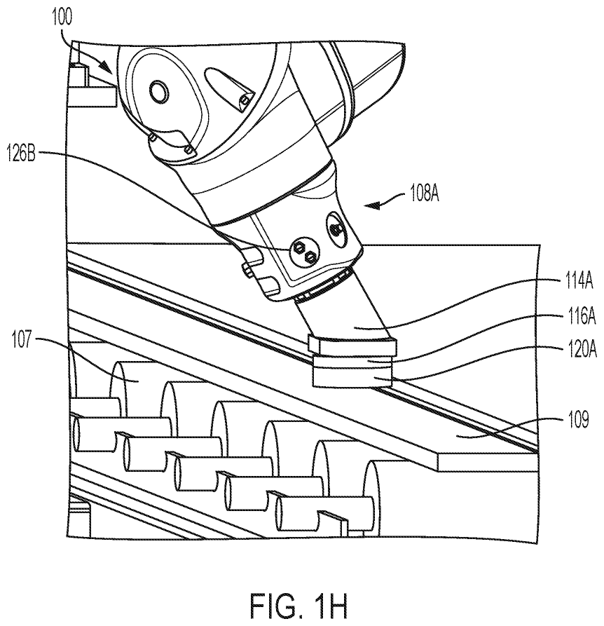

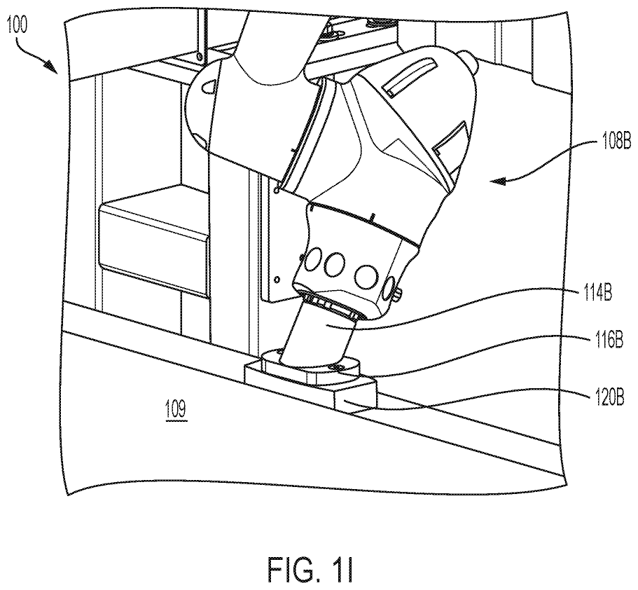

FIGS. 1A, 1B, and 1C are angled views of an example automated edge forming system 100 in accordance with various embodiments of the present disclosure. It will be understood that the FIGS. 1A-1C show the same angled view of the system 100, but that the FIGS. 1A-1C are organized as such to more clearly illustrate the various features of the exemplary system 100. As an overview, and as will be discussed later in this disclosure, according to some embodiments, FIG. 1A is intended to highlight the various devices of the system 100, FIG. 1B is intended to highlight the various components of these devices, and FIG. 1C is intended to highlight certain structural elements of the system, such as a platform and a production line. However, it will be understood that all of these devices and components of the system 100 are depicted in FIGS. 1A-1C.

FIGS. 1D and 1E are angled views of an example automated edge forming system 100 in accordance with various embodiments of the present disclosure. It will be understood that the FIGS. 1D and 1E show different angled views of the system 100, and that the FIGS. 1D and 1E are organized as such to more clearly illustrate additional various features of the system 100. It will be understood that the various components described with respect to FIGS. 1A-1C apply similarly to the system 100 and components in FIGS. 1D-1E, and vice-versa. It will further be understood that the system 100 shown in FIGS. 1A-1C may also include the components shown in FIGS. 1D-1E and described at related positions in the disclosure.

In some embodiments, the system 100 may include one or more sensing devices 102A, 102B. Though two sensing devices 102A, 102B are shown in at least FIGS. 1A-E, it will be understood that, in some embodiments, the system 100 may include more than two sensing devices and, in other embodiments, the system 100 may include fewer than two sensing devices. In some embodiments, the one or more sensing devices 102A, 102B may include respective first imaging components 104A, 104B (such as a lens) that may have a respective view profile. In some embodiments, the one or more sensing devices 102A, 102B may include a respective second imaging component 106A, 106B (such as a lens) that may have a respective view profile. In some embodiments, the one or more view profilers may be laser profilers. In some embodiments, the first and second imaging components 104A and 106A and 104B and 106B may operate in conjunction to create a single view profile. In other embodiments, each imaging component may create its own, separate view profile. In some embodiments, one or more cameras may be positioned on or otherwise integrated with the one or more sensing devices 102A, 102B. In various embodiments, the sensing devices 102A, 102B may be configured to detect or otherwise identify one or more profiles of one or more objects disposed on or along a production line 107. In other embodiments, the production line 107 may be an assembly line. In further embodiments, the production line 107 may be configured to produce gypsum board. In some embodiments, and as shown in at least FIGS. 1D-1I, a board 109 may be disposed on the production line 107. In some embodiments, the board 109 may be product boards, such as gypsum boards. In other embodiments, the board 109 may be lumber. It will be understood that a variety of product boards may be disposed on the production line 107. In some embodiments, the profiles of the gypsum board (or other product board, depending on the production line) may include, but are not limited to, the angle at which the board is cut (as will be discussed in further detail with reference to at least FIGS. 1F-1I), the dimensions of the board, the position at which the board is cut, the depth (or “dip”) at which the board is cut, and the length at which the board is cut. In some embodiments, the one or more sensing devices 102A, 102B may be configured to record and/or transmit view profiles to, for example, a control device, as will be described in greater detail later in this application. In some embodiments, the view profiles detected by the one or more sensing devices 102A, 102B may be profiles of products at various points on the production line 107 (e.g., before the product is cut, after the product is cut, or both).

In some embodiments, the one or more sensing devices 102A, 102B may be laser profilers. In some embodiments, the one or more sensing devices 102A, 102B may be KEYENCE Laser Profilers. In some embodiments, the laser profiler field of view 103A, 103B of the one or more sensing devices 102A, 102B may be indicated as at least FIG. 1D. In some embodiments, a protective cover 105A, 105B may be positioned over the one or more sensing devices 102A, 102B to, among other things, provide protection from debris created during production. In some embodiments, and as shown in at least FIGS. 1D, 1E, and 1H, the production line 107 may have a plurality of rollers.

In some embodiments, the system 100 may include one or more robotic devices 108A, 108B. Though two robotic devices 108A, 108B are shown in at least FIGS. 1A-E and 2, it will be understood that, in some embodiments, the system 100 may include more than two robotic devices and, in other embodiments, the system 100 may include fewer than two robotic devices. In some embodiments, each of the robotic devices 108A, 108B may include a number of articulating segments 110A, 110B, 112A, 112B, and 114A, 114B. In some embodiments, each of these articulating segments may move independently of and in relation to each other segment. In some embodiments, each of the robotic devices 108A, 108B may include a joint 116A, 116B disposed at a first end of the respective device. In some embodiments, the joint 116A, 116B may be a rotatable joint configured to rotate up to three-hundred-and-sixty degrees and relative to the respective robotic device. In some embodiments, the rotatable joint 116A, 116B may be controlled by the respective robotic device 108A, 108B, but it will be understood that, in other embodiments, the rotatable joint 116A, 116B may be controlled independently of the robotic device. In some embodiments, each of the robotic devices 108A, 108B may include a base 118A, 118B disposed at a second end of the respective device. In some embodiments, the base 118A, 118B may be configured to rotate up to three-hundred-and-sixty degrees. In some embodiments, the rotating base 118A, 118B may be configured to be controlled by the respective robotic devices 108A, 108B, but it will be understood that, in other embodiments, the respective bases may be controlled independently of the robotic devices. In some embodiments, the one or more robotic devices 108A, 108B may be described as robotic arms. In some embodiments, the one or more robotic devices 108A, 108B may adjust to operably engage with gypsum boards (or other product boards) ranging in widths from about 24 inches to about 54 inches. In some embodiments, the rotation of the rotatable joint 116A, 116B may be enabled by a roller bearing.

In some embodiments, the system 100 may include one or more edge forming devices 120A, 120B. Though two edge forming devices 120A, 120B are shown in at least FIGS. 1A-E and 2-3, it will be understood that, in some embodiments, the system 100 may include more than two edge forming devices and, in other embodiments, the system 100 may include fewer than two edge forming devices. In some embodiments, the one or more edge forming devices 120A, 120B may be described as edge forming shoes, or as forming shoes. In some embodiments, the edge forming devices 120A, 120B may be composed of stainless steel. In other embodiments, the edge forming devices 120A, 120B may be composed of chrome plated steel (or any kind of plated steel). In further embodiments, the edge forming devices 120A, 120B may be composed of aluminum, titanium, or a composite material It will be understood that, in other embodiments, the edge forming devices 120A, 120B may be composed of any suitable material for an edge forming device for use on a production line. In some embodiments, the one or more edge forming devices 120A, 120B may be fixedly connected to one or more joints 116A, 116B of the respective robotic devices 108A, 108B. In some embodiments, the edge forming devices 120A, 120B may be configured to rotate with the one or more joints 116A, 116B, when the joints are rotatable joints. In some embodiments, the one or more edge forming devices 120A, 120B may rotate independently of the joints 116A, 116B (that is, the edge forming devices 120A, 120B themselves rotate, not the joints, in some embodiments). In some embodiments, the edge forming devices 120A, 120B may be configured to be manipulated into one or more positions by the one or more robotic devices 108A, 108B. For example, in some embodiments, the one or more robotic devices 108A, 108B may manipulate the one or more edge forming devices 120A, 120B into a position wherein the one or more edge forming devices 120A, 120B are engaged with one or more objects on the production line 107. In some embodiments, this position may be referred to as an engagement position. For another example, in other embodiments, the robotic devices 108A, 108B may manipulate the one or more edge forming devices 120A, 120B into a position where the one or more edge forming devices 120A, 120B are disengaged from one or more objects on the production line 107. In some embodiments, this position may be referred to as a disengagement position. It will be understood that, in some embodiments, the one or more edge forming devices 120A, 120B may be configured to be simultaneously engaged with the one or more objects. It will be further understood that, in other embodiments, one of the one or more edge forming devices (e.g., 120A) may be configured to be engaged with the one or more objects on the production line 107 while another of the one or more edge forming devices (e.g., 120B) is configured to be disengaged with the one or more objects on the production line 107. In some embodiments, the rotatable joint 116A, 116B may be configured to rotate the edge forming device 120A, 120B such that the edge forming device 120A, 120B experiences less friction when engaged with an object on the production line 107. In some embodiments, the rotatable joint 116A, 116B may be configured to rotate to disengage the one or more edge forming devices 120A, 120B from an object on the production line 107. In some embodiments, the rotation of the edge forming devices 120A, 120B may be enabled by a roller bearing. In some embodiments, the edge forming devices 120A, 120B may rotate continuously when in contact with the product board (i.e., the devices 120A, 120B spin when in an engagement position) and then cease rotation when no longer engaged.

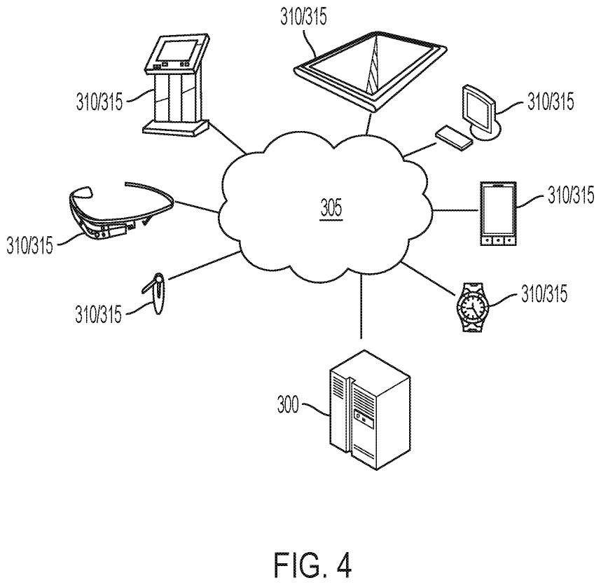

In some embodiments, the system 100 may include one or more control devices 122A, 122B. Though two control devices 122A, 122B are shown in at least FIGS. 1A-E and 2, it will be understood that, in some embodiments, the system 100 may include only one control device 122A or more than two control devices. In some embodiments, the one or more control devices 122A, 122B may be configured to control various elements of the system 100, including, but not limited to, the one or more sensing devices 102A, 102B, the one or more robotic devices 108A, 108B, the one or more rotatable joints 116A, 116B (either directly or through control of the robotic devices), and the one or more edge forming devices 120A, 120B. In some embodiments, the one or more control devices 122A, 122B may be configured to receive information from the one or more sensing devices 102A, 102B (e.g., view profiles of one or more objects on the production line 107). In other embodiments, the one or more control devices 122A, 122B may be configured to process the information received from the one or more sensing devices 102A, 102B into feedback. This feedback may include, for example, a new position into which the robotic device should move the edge forming device to engage the one or more objects on the production line 107. In further embodiments, the control device 102 may be configured to transmit information to the one or more robotic devices 108A, 108B (e.g., feedback based on the view profiles). Various embodiments of the control device 120 will be described in greater detail at later sections in this disclosure and at least in reference to FIGS. 4-6. In some embodiments, the one or more control devices 122A, 122B may be configured to provide feedback without input by a technician (i.e., the feedback is provided automatically to adjust the positioning of the edge forming devices 120A, 120B in response to view profiles detected by the one or more sensing devices 102A, 102B). In some embodiments, the one or more control devices 122A, 122B may be configured to control the one or more robotic devices 108A, 108B such that the one or more edge forming devices 120A, 120B may automatically engage and/or disengage with the one or more objects on the production line 107. However, it will also be understood that, in some embodiments, the one or more control devices 122A, 122B may be semi-autonomous and operated by a technician. It will be further understood that, in some embodiments, the one or more control devices 122A, 122B may be operated entirely on by a technician. In some embodiments, the one or more control devices 122A, 122B may be configured to control the one or more robotic devices 108A, 108B such that the robotic devices 108A, 108B manipulate the edge forming devices 120A, 120B into engaged positions and disengaged positions based on a timing system (i.e., engaged for one period of time, disengaged for another period of time, and then repeat). In some embodiments, the one or more control devices 122A, 122B may be KEYENCE programmable logic controllers (PLC). In various embodiments, the control devices 122A, 122B may control each of the individual components of the system.

In some embodiments, the one or more robotic devices 108A, 108B may be configured to apply a calibrated force through the edge forming devices 120A, 120B to one or more objects on the production line 107. In some embodiments, the amount of force applied may be configured by the one or more control devices 122A, 122B. In other embodiments, the amount of force may be set by a technician. In some embodiments, the one or more sensing devices 102A, 102B may be configured to determine the force applied by the one or more robotic devices 108A, 108B through the respective edge forming devices 120A, 120B. In some embodiments, sensors may be integrated into the one or more robotic devices 108A, 108B to provide force feedback for the system 100. In some embodiments, the force feedback may aid in preventing the robotic devices 108A, 108B from providing excessive force to an object on the production line 107. Further, in other embodiments, force feedback may aid in preventing the robotic devices 108A, 108B from pressing the edge forming devices 120A, 120B into the production line 107, which may damage the production line 107, damage the object being produced, and/or damage the edge forming devices 120A, 120B. In some embodiments, excessive force may be detected by resistance (e.g., from the production line 107) and/or by calibrating the system 100 by a technician. In some embodiments, and as shown in at least FIGS. 1D and 1E, the system 100 may include an actuator with a calibration plate 136 to enable the robotic devices 108A, 108B to apply a sufficient but not excessive amount of force to the board 109.

In some embodiments, the system 100 may include a platform 124. Though one platform is shown in at least FIGS. 1A-C and 2-3, it will be understood that, in some embodiments, the system 100 may include more than one platform 124 and, in other embodiments, that the various components of the system 100 may be distributed on the more than one platforms. In some embodiments, various components of the system 100 may be disposed on the platform 124. For example, in some embodiments, the one or more sensing devices 102A, 102B may be disposed on the platform 124. In some embodiments, the one or more sensing devices 102A, 102B may be disposed on respective protrusions 126A, 126B of the platform 124. In some embodiments, these protrusions 126A, 126B may be substantially triangular. In some embodiments, the platform 124 may include a plurality of slots 128A, 128B, 128C disposed along the platform 124. Though three slots 128A, 128B, 128C are shown on the platform 124 in at least FIGS. 1A-C, it will be understood that, in various embodiments, there may be more than three or fewer than three slots. In some embodiments, these slots 128A, 128B, 128C may function as one or more windows for viewing the production line 107 through the platform 124. In some embodiments, the one or more sensing devices 102A, 102B may be configured to look through one or more of the slots 128A, 128B, 128C to detect the one or more objects on the production line 107. For another example, in some embodiments, the one or robotic devices 108A, 108B may be disposed on the platform 124. In other embodiments, the one or more robotic devices 108A, 108B may be disposed on a respective first position on the platform and a respective second position on the platform. In further embodiments, the respective first position on the platform and the respective second position on the platform may be mirrored positions on the platform 124. In some embodiments, the one or more control devices 122A, 122B may be disposed on the platform 124. However, it will be understood that, in some embodiments, the one or more control devices 122A, 122B may be disposed in a location that is remote from the platform 124. For example, in some embodiments, the one or more control devices 122A, 122B may be a smart phone or other connected device that can connect to the system from a remote location. In other embodiments, one of the control devices (e.g., 122A) may be remote, while another control device (e.g., 122B) may be disposed on or near the platform 124. In some embodiments, the platform 124 may include a plurality of support structures 130A, 130B. In some embodiments, the one or more control devices 122A, 122B may be disposed on one of these support structures 130A, 130B. In some embodiments, the feedback loop described in this example (and elsewhere in this disclosure) may be automatic such that no user input is required to update the positioning of the one or more edge forming devices 120A, 120B. In some embodiments, the platform 124 may be configured such that the one or more robotic devices 108A, 108B may slide along the platform 124. In some embodiments, this sliding may be facilitated by a track 134 disposed on the platform 124 that is operably connected to the respective bases 118A, 118B of the one or more robotic devices 120A, 120B. In some embodiments, power for the various components of the system 100 may be run through the platform 124. In some embodiments, the platform 124 may be configured to be moved laterally along the production line 107. For example, the platform 124 may be disposed on a track aligned adjacent to the production line 107, which may enable the platform to move laterally to a new position on the production line 107. As another example, the platform 124 may have wheels that may enable the platform to move laterally to a new position on the production line 107.

In some embodiments, and as shown in at least FIG. 1D, the system 100 may include an attachment position 132 disposed on the platform 124. Though one attachment position 132 is shown in FIG. 1D, it will be understood that the platform 124 may include a plurality of attachment positions (e.g., 132A, 132B, one for each side of the platform 124). In some embodiments, the attachment position 132 may include a plurality of bolt holes, which may be used to attach various components to the system 100. However, it will be understood that other methods or fasteners may be used for the attachment position 132. In some embodiments, a cleaning device may be placed in this attachment position 132. In some embodiments, the cleaning device may be configured to clean the one or more edge forming devices 120A, 120B. In some embodiments, the one or more robotic devices 108A, 108B may be configured to manipulate the one or more edge forming devices 120A, 120B into the cleaning device. In some embodiments, the one or more control devices 122A, 122B may control the cleaning device. In some embodiments, the cleaning device may be disposed on the platform 124. However, it will be understood that, in other embodiments, the cleaning device may be disposed at a different location relative to the platform 124 and/or the production line 107. In some embodiments, there may be more than one cleaning device. In other embodiments, each cleaning device may be configured to clean a respective edge forming device 120A, 120B.

FIGS. 1F-1I are side and angled views of example edge forming devices 120A, 120B connected to robotic devices 108A, 108B, respectively, and engaged with a board 109 on the production line 107. It will be understood that the various components described above with respect to the system 100 apply similarly to FIGS. 1F-1I, and that FIGS. 1F-1I are intended to highlight certain features of the system. For example, in some embodiments, and as shown in at least FIGS. 1F and 1G, the edge forming device 120A, 120B may engage the board 109 at an angle of 87 degrees. It will be understood that, in some embodiments, the engagement angle could be greater or less than 87 degrees, depending on the product requirements. It will be further understood that, as described above, the angle may be adjusted based on the feedback system created by the sensing devices 102A, 102B and the control devices 122A, 122B. As another example, in other embodiments, and as shown in FIGS. 1H and 1I, the edge forming device 120A, 120B may have different shapes, being circular in FIG. 1H and substantially rectangular in FIG. 1I.

One example of the operation of the system 100 will now be described with reference to the various components previously discussed with respect to at least FIGS. 1A-I of this disclosure. The example will be described with respect to an embodiment relating gypsum board production, but it will be understood that the example is applicable to the production of various other products, not limited to gypsum production. It will further be understood that this example is not intended to be exclusive or preferred to any other examples in this disclosure. In some embodiments, the one or more edge forming devices 120A, 120B may be configured to cut board 109 on the production line 107 when the one or more edge forming devices 120A, 120B are manipulated into an engaged position by the one or more robotic devices 108A, 108B. In some embodiments, the one or more sensing devices 102A, 102B may detect that the one or more edge forming devices 120A, 120B are cutting the gypsum board into an undesirable configuration (e.g., the cutting angle is not desirable). In some embodiments, this undesirable positioning may be detected by the one or more sensing devices 102A, 102B by detecting the view profiles of one or more objects on the production line 107 (e.g., the sensing devices detect at what angle the board 109 is being cut). In some embodiments, the one or more sensing devices 102A, 102B may then transmit those view profiles to the control device 122, which may then process that information into feedback and transmit it to the one or more robotic devices 108A, 108B). The one or more robotic devices 108A, 108B may then adjust the engaged position of the one or more edge forming devices 120A, 120B such that the gypsum board is no longer cut in the undesirable way (e.g., the angle at which the board is cut is increased or decreased). In some embodiments, the respective rotatable joints 116A, 116B may also be configured to rotate the one or more edge forming devices 120A, 120B in response to this feedback. Alternatively, the one or more edge forming devices may themselves rotate. Furthermore, in some embodiments, when the edge forming devices are not engaged with the board 109, the one or more control devices 122A, 122B may send a signal not to rotate the edge forming devices. In at least this way, the control devices 122A, 122B, in some embodiments, may facilitate a feedback loop that leads to optimal positioning and/or optimal rotation timing for the one or more edge forming devices 120A, 120B.

In some embodiments, the system 100 may be configured to interact with and/or collaborate with other systems. In some embodiments, these other systems may be similarly configured to interact with the production line 107. However, it will be understood that the system 100 may interact with a variety of other systems, including those not configured to interact with the production line 107 (or another production line). In some embodiments, the system 100 may be configured to interact with a forming arm system. In some embodiments, the system 100 may be configured to interact with a creaser system.

In some embodiments, one or more cameras or similar viewing devices may be disposed on various components of the system 100. For example, in some embodiments, various cameras or viewing devices may be disposed on the one or more robotic devices 108A, 108B. In other embodiments, one or more cameras may be positioned on the production line 107, or adjacent to the production line 107.

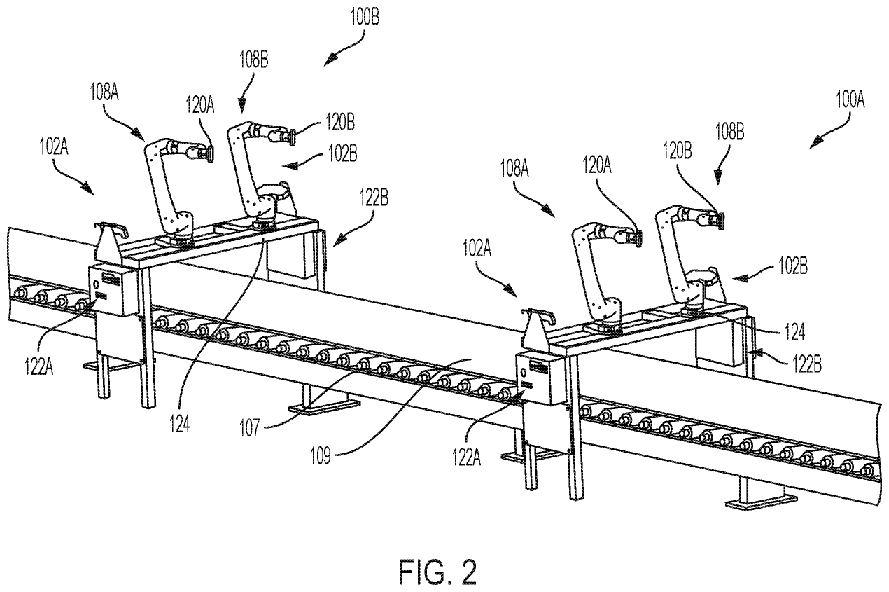

FIG. 2 is an angled view of an example production line 107 with example automated edge forming systems 100A, 100B in accordance with various embodiments of the present disclosure. It will be understood that the edge forming systems 100A, 100B may be the edge forming system 100 as described previously in this disclosure. However, it will also be understood that, in some embodiments, the edge forming systems 100A, 100B may be modified for the production line 107. For example, in some embodiments, the edge forming systems 100A, 100B may be synchronized to operate in unison. Although at least FIG. 2 shows that each automated edge forming system 100A, 100B has a respective control device 122A, 122B, it will be understood that, in some embodiments, a single control device may control each system 100A, 100B. For example, in some embodiments, the edge forming system 100A may provide feedback to the respective control device (e.g., 122A), which may then provide feedback to the second system 100B. In at least this way, the systems 100A, 100B may “cascade” feedback to one another. Though two systems 100A, 100B are shown on the production line 107, it will be understood that more than two systems may be used on the production line 107. In some embodiments, other components of one system may be linked to another (e.g., the robotic devices, the sensing devices, the edge forming devices, and/or the cleaning system may be linked between systems).

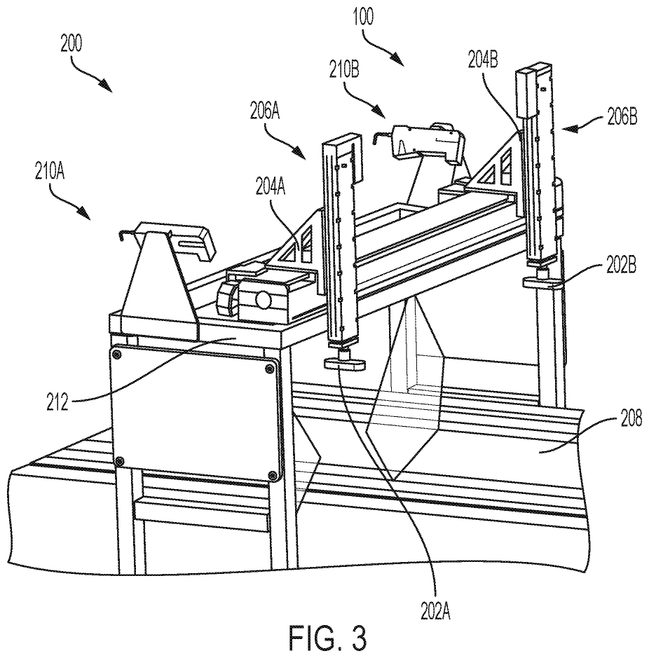

FIG. 3 is an angled view of an example edge forming system 200 that does not include a control device or robotic devices. Instead, the system 200 may require manual adjustment of the location of one or more edge forming devices 202A, 202B by means of mounting brackets 204A, 204B that are connected to arms 206A, 206B. In some embodiments, linear actuators may be used to move the arms 206A, 206B. The one or more brackets 204A, 204B may be manually adjusted into position by a technician to interact with one or more objects on the production line 208. The system 200 may include one or more sensors 210A, 210B. These various components may be distributed on a platform 212. The system 200 may require manual monitoring by a technician to change the position and orientation of the edge forming devices 202A, 202B.

### Example Computer Program Products, Systems, Methods, and Computing Entities

The structure and operation of the one or more control devices 122A, 122B will now be described in greater detail. It will be understood that the description is provided in reference to the system 100 described previously in this disclosure. However, it will also be understood that the description may also apply to a variety of other compatible systems and devices.

### Exemplary System Architecture

FIG. 4 provides an illustration of an exemplary system architecture that may be used in accordance with various embodiments of the present disclosure. As shown in FIG. 4, the architecture may include one or more management computing entities 300, one or more networks 305, and one or more user computing entities 315. Each of these components, entities, devices, systems, and similar words used herein interchangeably may be in direct or indirect communication with, for example, one another over the same or different wired or wireless networks 305. Additionally, while FIG. 4 illustrates the various system entities as separate, standalone entities, the various embodiments are not limited to this particular architecture.

### Exemplary Management Computing Entity

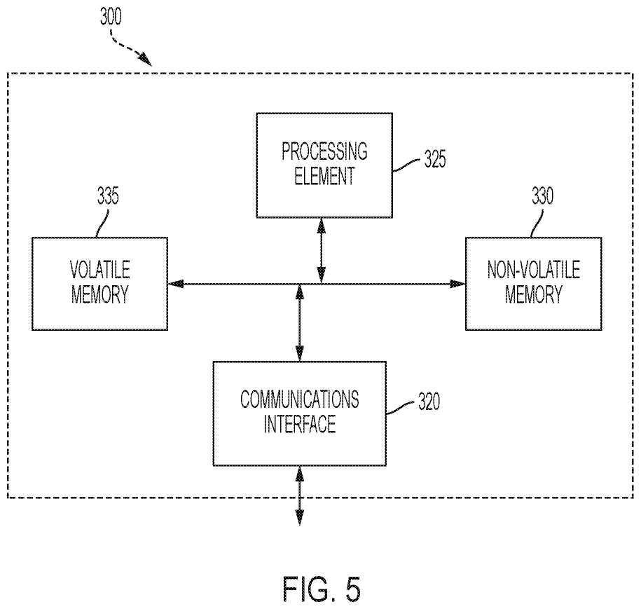

FIG. 5 provides a schematic of a management computing entity 300 that may be used with the one or more control devices 122A, 122B according to one embodiment of the present disclosure. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In some embodiments, the management computing entity 300 may be integrated with or otherwise operably connected with the one or more control devices 122A, 122B.

As indicated, in one embodiment, the management computing entity 300 may also include one or more communications interfaces 320 for communicating with various computing entities, such as by communicating data, content, information, and/or similar terms used herein interchangeably that can be transmitted, received, operated on, processed, displayed, stored, and/or the like. For instance, the management computing entity 300 may communicate with user computing entities 310 and/or a variety of other computing entities. In some embodiments, these communication interfaces 320 may be integrated with or otherwise operably connected to the one or more control devices 122A, 122B. In other embodiments, these communications interfaces 320 may communicate between one or more components of the system 100. In further embodiments, these communications interfaces 320 may be integrated with or operably connected to various components of the system 100.

As shown in FIG. 5, in one embodiment, the management computing entity 300 may include or be in communication with one or more processing elements 325 (also referred to as processors, processing circuitry, and/or similar terms used herein interchangeably) that communicate with other elements within the management computing entity 300 via a bus, for example. As will be understood, the processing element 325 may be embodied in a number of different ways. For example, the processing element 325 may be embodied as one or more complex programmable logic devices (CPLDs), microprocessors, multi-core processors, coprocessing entities, application-specific instruction-set processors (ASIPs), microcontrol devices, and/or control devices. Further, the processing element 325 may be embodied as one or more other processing devices or circuitry. The term circuitry may refer to an entirely hardware embodiment or a combination of hardware and computer program products. Thus, the processing element 325 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 325 may be configured for a particular use or configured to execute instructions stored in volatile or non-volatile media or otherwise accessible to the processing element 325. As such, whether configured by hardware or computer program products, or by a combination thereof, the processing element 205 may be capable of performing steps or operations according to embodiments of the present disclosure when configured accordingly.

In one embodiment, the management computing entity 300 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 330, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the management computing entity 300 may further include or be in communication with volatile media (also referred to as volatile storage, memory, memory storage, memory circuitry and/or similar terms used herein interchangeably). In one embodiment, the volatile storage or memory may also include one or more volatile storage or memory media 335, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 325. Thus, the databases, database instances, database management systems, data, applications, programs, program modules, scripts, source code, object code, byte code, compiled code, interpreted code, machine code, executable instructions, and/or the like may be used to control certain aspects of the operation of the management computing entity 300 with the assistance of the processing element 325 and operating system.

As indicated, in one embodiment, the management computing entity 300 may also include one or more communications interfaces 320 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity 300 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1×(1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the management computing entity 300 may include or be in communication with one or more input elements, such as a keyboard input, a mouse input, a touch screen/display input, motion input, movement input, audio input, pointing device input, joystick input, keypad input, and/or the like. The management computing entity 300 may also include or be in communication with one or more output elements (not shown), such as audio output, video output, screen/display output, motion output, movement output, and/or the like.

As will be appreciated, one or more of the management computing entity's 300 components may be located remotely from other management computing entity 300 components, such as in a distributed system. Furthermore, one or more of the components may be combined and additional components performing functions described herein may be included in the management computing entity 300. Thus, the management computing entity 300 can be adapted to accommodate a variety of needs and circumstances. As will be recognized, these architectures and descriptions are provided for exemplary purposes only and are not limiting to the various embodiments.

### Exemplary User Computing Entity

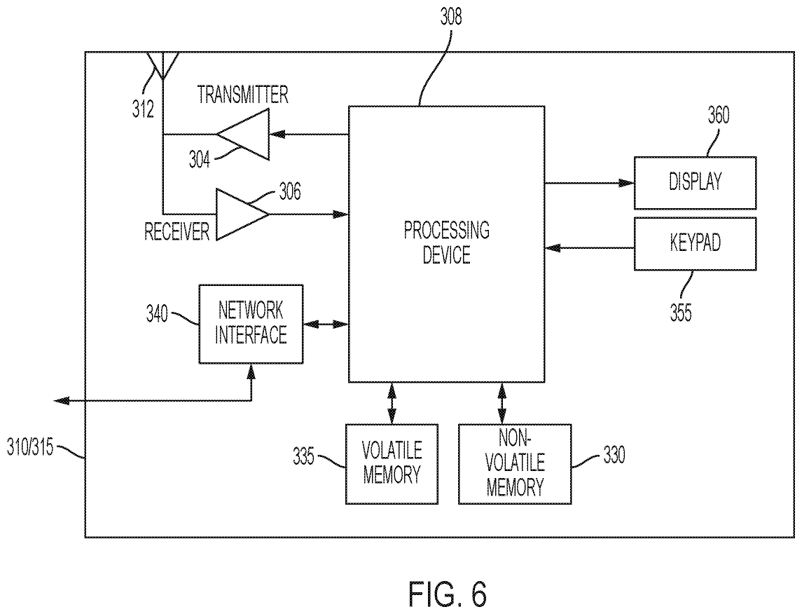

A user may be an individual, a family, a company, an organization, an entity, a department within an organization, a representative of an organization and/or person, and/or the like. To do so, a user may operate a user computing entity 310 that includes one or more components that are functionally similar to those of the management computing entity 300. FIG. 6 provides an illustrative schematic representative of a user computing entity 310 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 310 can be operated by various parties. As shown in FIG. 6, the user computing entity 310 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrol devices, and/or control devices) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the user computing entity 310 may be capable of operating with one or more air interface standards, communication protocols, modulation types, and access types. More particularly, the user computing entity 310 may operate in accordance with any of a number of wireless communication standards and protocols, such as those described above with regard to the management computing entity 300. In a particular embodiment, the user computing entity 310 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 310 may operate in accordance with multiple wired communication standards and protocols, such as those described above with regard to the management computing entity 300 via a network interface 340.

Via these communication standards and protocols, the user computing entity 310 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 310 can also download changes, add-ons, and updates, for instance, to its firmware, software (e.g., including executable instructions, applications, program modules), and operating system.

According to one embodiment, the user computing entity 310 may include location determining aspects, devices, modules, functionalities, and/or similar words used herein interchangeably. For example, the user computing entity 310 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user computing entity's 310 position in connection with a variety of other systems, including cellular towers, Wi-Fi access points, and/or the like. Similarly, the user computing entity 310 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user computing entity 310 may also comprise an interactive electronic technical manual (IETM) viewer (that can include a display 345 coupled to a processing element 350) and/or a viewer (coupled to a processing element 350). In some embodiments, the user computing entity 310 may be integrated with the one or more control devices 122A, 122B to, among other things, provide a way for technicians to interact with the control device 122A, 122B and thereby control the system 100. It will be understood that this is merely an exemplary manner of interaction and that a technician may operate with the one or more control devices 122A, 122B and the system 100 by any suitable means.

In some embodiments, the IETM viewer may be a user application, browser, user interface, graphical user interface, and/or similar words used herein interchangeably executing on and/or accessible via the user computing entity 310 to interact with and/or cause display of information from the management computing entity 300, as described herein. The term “viewer” is used generically and is not limited to “viewing.” Rather, the viewer is a multi-purpose digital data viewer capable and/or receiving input and providing output. The viewer can comprise any of a number of devices or interfaces allowing the user computing entity 310 to receive data, such as a keypad 355 (hard or soft), a touch display, voice/speech or motion interfaces, or other input device. In embodiments including a keypad 355, the keypad 355 can include (or cause display of) the conventional numeric (0-9) and related keys (#, *), and other keys used for operating the user computing entity 310 and may include a full set of alphabetic keys or set of keys that may be activated to provide a full set of alphanumeric keys. In addition to providing input, the viewer can be used, for example, to activate or deactivate certain functions, such as screen savers and/or sleep modes.

The user computing entity 310 can also include volatile storage or memory 335 and/or non-volatile storage or memory 330, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 310. As indicated, this may include a user application that is resident on the entity or accessible through a browser or other IETM viewer for communicating with the management computing entity 300 and/or various other computing entities.

In another embodiment, the user computing entity 310 may include one or more components or functionality that are the same or similar to those of the management computing entity 100, as described in greater detail above. As will be recognized, these architectures and descriptions are provided for exemplary purposes only and are not limiting to the various embodiments.

### Exemplary System Operations

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. Greater or fewer operations may be performed than shown in the figures and described herein. These operations may also be performed in a different order than those described herein.

As described above, the management computing entity 300 and/or user computing entity 310 may be configured for storing technical documentation (e.g., data) in an IETM, providing access to the technical documentation to a user via the IETM, and/or providing functionality to the user accessing the technical documentation via the IETM. In general, the technical documentation is typically made up of volumes of text along with other media objects. In many instances, the technical documentation is arranged to provide the text and/or the media objects on an item. For instance, the item may be a product, machinery, equipment, a system, and/or the like such as, for example, a bicycle or an aircraft.

Accordingly, the technical documentation may provide textual information along with non-textual information (e.g., one or more visual representations) of the item and/or components of the item. Textual information generally includes alphanumeric information and may also include different element types such as graphical features, controls, and/or the like. Non-textual information generally includes media content such as illustrations (e.g., 2D and 3D graphics), video, audio, and/or the like. Although the non-textual information may also include alphanumeric information.

The technical documentation may be provided as digital media in any of a variety of formats, such as JPEG, JFIF, JPEG2000, EXIF, TIFF, RAW, DIV, GIF, BMP, PNG, PPM, MOV, AVI, MP4, MKV, and/or the like. In addition, the technical documentation may be provided in any of a variety of formats, such as DOCX, HTMLS, TXT, PDF, XML, SGML, JSON and/or the like. As noted, the technical documentation may provide textual and non-textual information of various components of the item. For example, various information may be provided with respect to assemblies, sub-assemblies, sub-sub-assemblies, systems, subsystems, sub-subsystems, individual parts, and/or the like associated with the item.

In various embodiments, the technical documentation for the item may be stored and/or provided in accordance with S1000D standards and/or a variety of other standards. According to various embodiments, the management computing entity 300 and/or user computing entity 310 provides functionality in the access and use of the technical documentation provided via the IETM in accordance with user instructions and/or input received from the user via an IETM viewer (e.g., a browser, a window, an application, a graphical user interface, and/or the like).

Accordingly, in particular embodiments, the IETM viewer is accessible from a user computing entity 310 that may or may not be in communication with the management computing entity 300. For example, a user may sign into the management computing entity 300 from the user computing entity 310 or solely into the user computing entity 310 to access technical documentation via the IETM and the management computing entity 300 and/or user computing entity 310 may be configured to recognize any such sign in request, verify the user has permission to access the technical documentation (e.g., by verifying the user's credentials), and present/provide the user with various displays of content for the technical documentation via the IETM viewer (e.g., displayed on display 360).

Further detail is now provided with respect to various functionality provided by embodiments of the present disclosure. As one of ordinary skill in the art will understand in light of this disclosure. The modules now discussed and configured for carrying out various functionality may be invoked, executed, and/or the like by the management computing entity 300, the user computing entity 310, and/or a combination thereof depending on the embodiment.

### Example Methods of Use

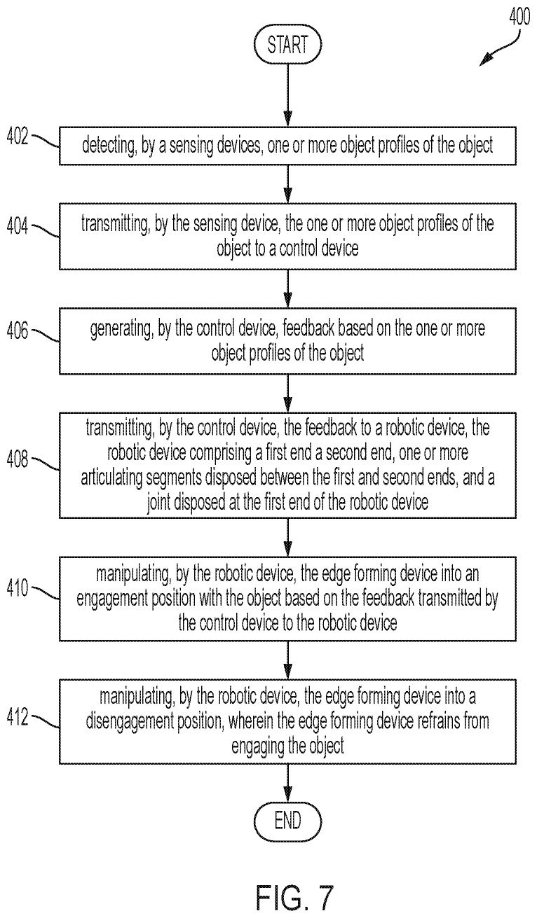

FIG. 7 is a flow chart illustrating an example method 400 of making an object with example automated edge forming system 100 in accordance with various embodiments of the present disclosure. The method 400 is described below with reference to the system 100 described previously in the disclosure, as well as with reference to the systems, devices, and apparatuses described with respect to the one or more control devices 122A, 122B, the FIGS. 4-6, and the associated portions of the disclosure. However, it will be understood that, in some embodiments, the method 400 may be performed with respect to a variety of suitable systems, devices, and apparatuses.

In some embodiments, there is provided a method 400 of making an object. In some embodiments, the method 400 includes a step 402 detecting, by a sensing devices, one or more profiles of the object. In other embodiments, the method 400 includes a step 404 of transmitting, by the sensing device, the one or more profiles of the object to a control device. In further embodiments, the method 400 includes a step 406 of generating, by the control device, feedback based on the one or more profiles of the object. In additional embodiments, the method 400 includes a step 408 of transmitting, by the control device, the feedback to a robotic device, the robotic device comprising a first end and a second end, one or more articulating segments disposed between the first and second ends, and a joint disposed at the first end of the robotic device. In some embodiments, the method 400 includes a step 410 of manipulating, by the robotic device, the edge forming device into an engagement position with the object based on the feedback transmitted by the control device to the robotic device. In other embodiments, the method 400 includes a step 412 of manipulating, by the robotic device, the edge forming device into a disengagement position, wherein the edge forming device refrains from engaging the object.

In some embodiments, the method 400 may be performed sequentially (i.e., step 402 is performed before step 404, which is performed before step 406, and so on). However, it will be understood that, in some embodiments, the steps of the method 400 may be performed in a variety of orders and sequences to achieve a desired outcome.

### Conclusion

Many modifications and other various embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific various embodiments disclosed and that modifications and other various embodiments are intended to be included within the scope of the appended claims. Although specific terms are employed herein, they are used in a generic and descriptive sense only and not for purposes of limitation.

1. An automated edge forming system comprising:
a sensing device configured to detect one or more profiles of one or more objects disposed on a production line;
a robotic device comprising a first end and a second end, one or more articulating segments disposed between the first and second ends, and a joint disposed at the first end of the robotic device,
an edge forming device fixedly connected to the joint of the robotic device,
wherein the robotic device is configured to position the edge forming device between an engaged position and a disengaged position,
wherein the edge forming device is configured to engage the one or more objects on the production line when the edge forming device is in the engaged position, and
wherein the edge forming device is configured to refrain from engaging the one or more objects on the production line when the edge forming device is in the disengaged position; and
a control device configured to receive the one or more profiles of the one or more objects from the sensing device, process the one or more profiles into feedback, and provide the feedback to the robotic device,
wherein the robotic device is configured to adjust the engaged position of the edge forming device based on the feedback.

2. The automated edge forming system of claim 1, wherein the joint of the robotic device is a rotational joint configured to spin continuously the edge forming device when the edge forming device is in the engaged position.

3. The automated edge forming system of claim 1, wherein the edge forming device is configured to spin continuously when the edge forming device is in the engaged position.

4. The automated edge forming system of claim 1 further comprising a cleaning device configured to clean the edge forming device when the edge forming device is in the disengaged position.

5. The automated edge forming system of claim 1 further comprising a platform adjacent to the production line,
wherein the sensing device is positioned at a first location on the platform, and
wherein the robotic device is positioned at a second location on the platform.

6. The automated edge forming system of claim 5 further comprising:
a second sensing device positioned at a third location on the platform and configured to detect the one or more profiles of the one or more objects disposed on the production line;
a second robotic device positioned at a fourth location on the platform and comprising a first end and a second end, one or more articulating segments disposed between the first and second ends, and a joint disposed at the first end of the robotic device; and
a second edge forming device fixedly connected to the joint of the second robotic device,
wherein the second robotic device is configured to position the second edge forming device between an engaged position and a disengaged position,
wherein the second edge forming device is configured to engage the one or more objects on the production line when the edge forming device is in the engaged position, and
wherein the second edge forming device is configured to refrain from engaging the one or more objects on the production line when the edge forming device is in the disengaged position,
wherein the control device is configured to receive the one or more profiles of the one or more objects from the second sensor, process the one or more profiles into feedback, and provide the feedback to the second robotic device,
wherein the second robotic device is configured to adjust the engaged position of the edge forming device based on the feedback.

7. The automated edge forming system of claim 6, wherein the first edge forming device and the second edge forming device are configured to be simultaneously engaged with the same object when the first edge forming device and the second edge forming device are in their respective engaged positions.

8. The automated edge forming system of claim 6, wherein the robotic device is configured to slidably move along the platform relative to one or more of the sensing device and the production line.

9. The automated edge forming system of claim 6, wherein the platform is positioned above the production line.

10. The automated edge forming system of claim 6, wherein the platform comprises a plurality of slots, and wherein the sensing device may be configured to detect through one or more of the plurality of slots the one or more profiles of one or more objects disposed on the production line.

11. The automated edge forming system of claim 1, wherein the robotic device further comprises a base disposed on the robotic device's second end, wherein the base is configured to rotate up to three-hundred-and-sixty degrees.

12. The automated edge forming system of claim 1, wherein the one or more objects on the production line comprise one or more gypsum boards, and wherein the engagement of the edge forming device with the one or more objects on the production line comprises cutting the one or more gypsum boards.

13. The automated edge forming system of claim 1, wherein the one or more profiles of the object comprise one or more of an angle at which the edge forming device is in the engaged position with the one or more objects, a position of the one or more objects on the production line, a depth at which the edge forming device is in the engaged position with the one or more objects.

14. The automated edge forming system of claim 1, wherein the robotic device is configured to have six degrees of freedom of movement.

15. The automated edge forming system of claim 1, wherein the sensing device is a laser profiler.

16. A method of making an object, the method comprising:
detecting, by a sensing devices, one or more profiles of the object;
transmitting, by the sensing device, the one or more profiles of the object to a control device;
generating, by the control device, feedback based on the one or more profiles of the object;
transmitting, by the control device, the feedback to a robotic device, the robotic device comprising a first end and a second end, one or more articulating segments disposed between the first and second ends, and a joint disposed at the first end of the robotic device,
wherein an edge forming device is fixedly attached to the joint of the robotic device;
manipulating, by the robotic device, the edge forming device into an engagement position with the object based on the feedback transmitted by the control device to the robotic device; and
manipulating, by the robotic device, the edge forming device into a disengagement position, wherein the edge forming device refrains from engaging the object.

17. The method of claim 16, wherein the object comprises gypsum board, and the method further comprises cutting, by the edge forming device, the gypsum board.

18. The method of claim 16, wherein the joint of the robotic device is a rotational joint and the method further comprises continuously spinning, by means of the rotational joint, the edge forming device.

19. The method of claim 16, further comprising continuously spinning the edge forming device.

20. The method of claim 16, further comprising moving, by the robotic device, the edge forming device into a cleaning device configured to clean the edge forming device.
